(19) United States
(12) Patent Application Publication
(10) Pub. No.: US 2010/0141571 A1
(43) Pub. Date: Jun. 10, 2010

(54) Image Sensor with Integrated Light Meter for Controlling Display Brightness

(76) Inventors: Tony Chiang, Tainan (TW); Amit Mittra, Tainan (TW)

Correspondence Address: STOUT, UXA, BUYAN & MULLINS LLP, 4 VENTURE, SUITE 300, IRVINE, CA, 92618, US

(21) Appl. No.: 12/331,426

(22) Filed: Dec. 9, 2008

(51) Int. Cl. G09G 3/36

(52) U.S. Cl. 345/102

(57) ABSTRACT

The present invention is directed to an image sensor with an integrated light meter that can be used to automatically adjust the display brightness based on ambient light in the environment. According to one embodiment, an automatic exposure (AE) control loop estimates the ambient light when the image sensor is imaging, and the image sensor measures the ambient light when the image sensor is not imaging.

### BACKGROUND OF THE INVENTION

1. Field of the Invention

The present invention generally relates to image sensors, and more particularly, to an image sensor with an integrated ambient light meter for controlling electronic display brightness.

2. Description of the Prior Art

Electronic devices utilize display devices to effectively communicate information. Different display technologies, such as Liquid Crystal Displays (LCD), Organic Light Emitting Diodes (OLED), Field Emission Displays, and Plasma Displays, are selected for use depending on the intended application.

The LCD and OLED are flat display devices that have the advantage of being thinner and lighter over conventional displays, such as cathode ray tube displays, and thus receive widespread popularity in a wide range of modern electronic device applications.

The LCD is constructed as transmissive LCD, reflective LCD or transreflective LCD, differing by the relative alignment between light source and liquid crystal (LC) molecules. The transmissive LCD is made of the LC molecules arrayed in front of, and illuminated by, a backlight module (“backlight”). The reflective LCD is made of the LC molecules and a reflector that reflects ambient light to illuminate the LC molecules. The transreflective LCD uses both backlighting and reflecting methods to illuminate the LC molecules.

The backlight mentioned above may be built from a variety of lighting elements, such as light emitting diode (LED), cold cathode fluorescent lamp (CCFL), or electroluminescence panel (ELP). Among these lighting elements, the LED is currently emerging as the preferred technology due to its long lifetime, low cost, resilience to vibration, low voltage and precise control of its intensity.

The OLEDs are composed of light-emitting organic materials. The material emits light when it is excited by an electric current, and as a result requires no backlighting. The amount of electric current can be actively controlled within the OLED structure, thereby controlling the brightness of the display.

In order to conserve power, such as in a handheld or portable electronic device, the display brightness may be adaptively adjusted based on the available light (or ambient light) in the environment surrounding the display. For example, the display is dimmed in a dark room, whereas the display intensity is increased in a bright lighting condition. Furthermore, controllability of the LCD display has the added benefit of reducing eye strain on the user and increasing visibility of the display. A conventional method of controlling the display brightness mentioned above involves employing a small discrete photo sensor to measure the ambient light. A control loop is employed to adjust the brightness based on measured ambient light.

An image sensor is also a crucial electronic component that is widely used in modern electronic devices. Particularly, semiconductor-based image sensors, such as charge-coupled devices (CCDs) or complementary metal-oxide-semiconductor (CMOS) image sensors (commonly referred to as CISs), are popular in, for example, cameras and camcorders for converting images of visible light into electronic signals that can then be stored, transmitted and/or displayed. As image sensors consume substantially more power than discrete photo sensors, image sensors are seldomly used, if at all, for controlling the backlight particularly in portable electronic devices or battery-operated devices.

For devices that contain an image sensor, a separate ambient light sensor is still needed for brightness adjustment. This solution increases the cost, space and complexity of the device design. For the above reasons, a need has arisen to propose a novel method and apparatus for an image sensor that can be used to automatically adjust the display brightness based on the ambient light in the environment.

### SUMMARY OF THE INVENTION

In view of the foregoing, it is an object of the present invention to provide a method and apparatus for an image sensor to automatically adjust the display brightness based on the ambient light in the environment, while reducing system cost and space, as well as attenuating substantial power consumption.

According to the embodiments, the present invention provides an image sensor with an integrated light meter for controlling display brightness. Since the photodiode of an image sensor is continuously exposed and collecting a light signal, the light signal is measured using the proposed light meter when the image sensor is not imaging. While the sensor is imaging, the light intensity can be approximated using the required Exposure and Gain Product (EGP) calculated by the on-chip Automatic Exposure (AE) Control Loop. For an image sensor without on-chip AE Control Loop, the sensor's exposure and gain setting, calculated and applied by off-chip AE Control Loop, can be characterized and approximated to light intensity. The sensor chip can include dedicated light intensity measurement circuits capable of quantifying light intensity when the exposure and gain of the sensor can no longer be adjusted. The relationship of light intensity, measured by a dedicated measurement circuit and/or approximated by the EGP value and the integrated light meter, is correlated with the illuminance (or luminance) of the ambient light, and is utilized to control the display brightness.

### BRIEF DESCRIPTION OF THE DRAWINGS

FIG. 1A illustrates an apparatus for an image sensor with an integrated ambient light meter that can be used to automatically adjust the LCD display brightness based on ambient light, according to one embodiment of the present invention;

FIG. 1B shows a typical EGP curve illustrating the relationship between the EGP and illuminance (or luminance);

FIG. 1C illustrates a detailed block diagram of the digitize/store block of FIG. 1A;

FIG. 2A illustrates an apparatus for an image sensor with an off-chip auto exposure (AE) control loop according to an alternative embodiment of the present invention;

FIG. 2B shows a typical EGP curve illustrating the relationship between the EGP and illuminance;

FIG. 3A illustrates the image sensor with an integrated ambient light meter for controlling electronic display brightness when the image sensor is not used for capturing and outputting image data;

FIG. 3B illustrates the resetting and integrating of the image sensor when the image sensor is not used for capturing and outputting image data;

FIG. 3C shows an intensity curve illustrating the relationship between the light signal and illuminance; and

FIG. 3D shows the difference between the intensity curve of FIG. 3C and the EGP curve of FIGS. 1B and/or 2B.

### DETAILED DESCRIPTION OF THE INVENTION

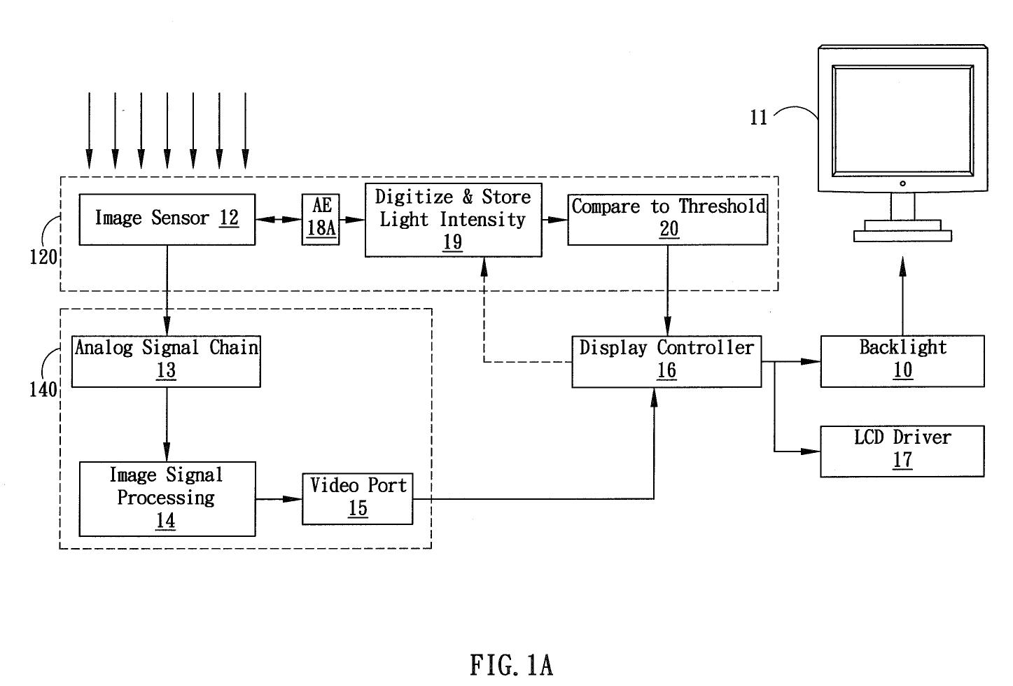

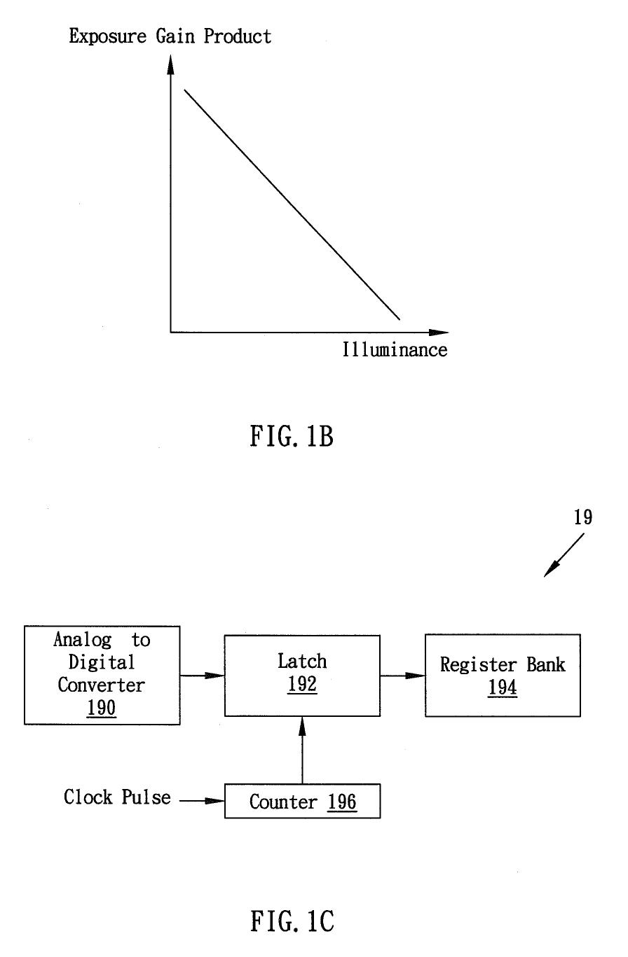

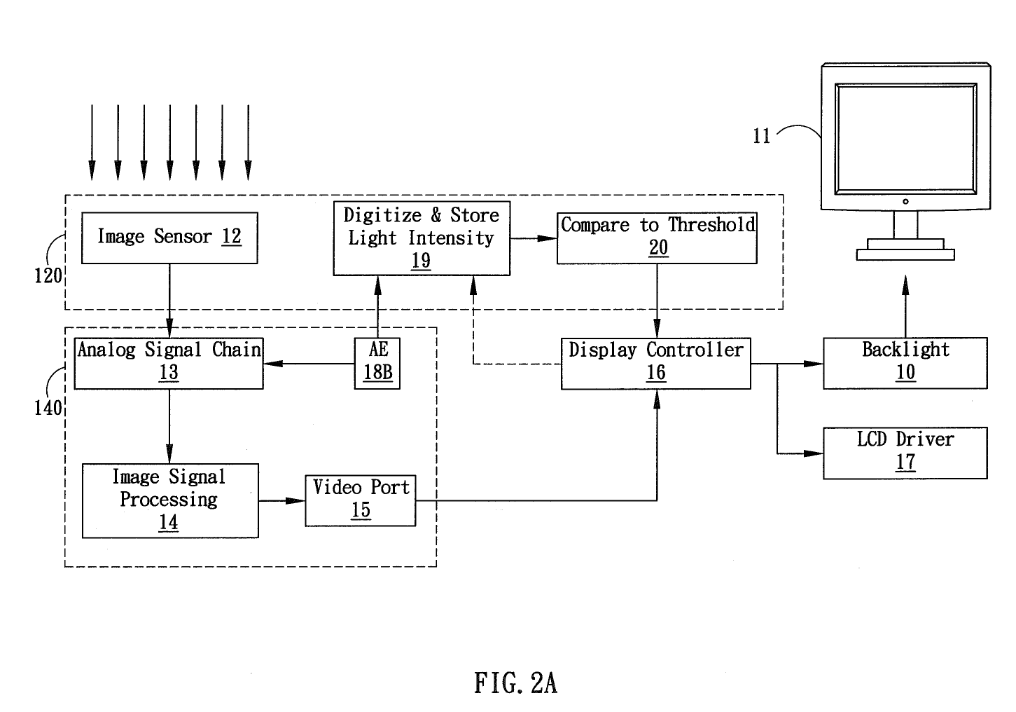

FIG. 1A illustrates an apparatus for an image sensor 12 with an integrated ambient light meter that can be used to automatically adjust the display brightness of, but is not limited to, a liquid crystal display (LCD) 11 based on ambient light, according to one embodiment of the present invention. In the embodiment, the image sensor 12 is configured, associated with other blocks that will be described later in this specification, to function as a light meter. The image sensor 12 is preferably a complementary metal-oxide-semiconductor (CMOS) image sensor (commonly referred to as CIS) in the present embodiment; however, other image sensors, such as a charge-coupled device (CCD), could be used instead. The integrated light meter operates differently in two modes, which can be referenced as a first mode in which the image sensor 12 is for capturing and outputting image data (or is imaging), and a second mode in which the image sensor 12 is not for capturing and outputting image data (or is not imaging).

### Mode I

With respect to the embodiment illustrated in FIG. 1A, an on-chip auto exposure (AE) control loop 18A is placed on the same chip 120 as the image sensor 12. The AE control loop 18A contains dedicated circuits and/or algorithms, which are configured to measure the light intensity on the image sensor 12. The measurement of the light intensity by the AE control loop 18A is used to control the exposure time of the image sensor 12 and the applied gain to the sensor signals, such that the image produced by the image sensor 12 is properly exposed. It is appreciated by persons skilled in the art that the AE algorithm and the ISP are well known, and therefore, their respective details, except those relevant to the present embodiment, are purposely omitted for brevity.

When the image sensor 12 is capturing and outputting image data, signals generated by light falling on the sensor photodetectors of the image sensor 12 are amplified and read out of the image sensor 12, and the digital equivalent is then output by analog signal chain 13. The output digital signals are usually further processed by the (digital) image signal processor (ISP) 14, and are then forwarded to a video port or video bus 15. Subsequently, a display controller 16, a main circuit in a video signal generator responsible for the production of the video signal, directs the digital signal to a LCD driver 17, which drives and displays the image on the display 11.

While the image sensor 12 is capturing and outputting image data, the ambient light intensity of the scene can be directly measured from the image data. In the embodiment, the AE control loop 18A utilizes analog gain, digital gain and integration time to control the exposure time (i.e., how long the image sensor 12 is exposed to incident light), as well as the amount of (analog and/or digital) gain applied to the signals out of the image sensor 12. The AE control loop compares the measured light intensity to a programmable target light intensity and calculates the exposure time and gain (analog and/or digital) required to converge the measured and target light intensity. An AE exposure gain product (EGP) is thus obtained by multiplying the exposure time by the total gain (e.g., analog and digital). A typical EGP curve showing the relationship between the EGP and illuminance (or luminance, or light intensity) is illustrated in FIG. 1B. According to this EGP curve, the EGP has a substantially linear relationship to the illuminance as shown, and the EGP may then be utilized to determine the light intensity of the ambient light. Subsequently, the EGP curve is then quantified and/or digitized and stored (block 19). When the system in FIG. 1A is operating, the corresponding light intensity of the ambient light is determined in the block 19, followed by comparing it to a predetermined threshold (in block 20) to, accordingly, control the brightness of the display which, in this embodiment, is controlled by the backlight module (“backlight”) 10. In some embodiments, however, the brightness of the display 11 can be controlled by adjusting the light source, and, alternatively in other embodiments, by adjusting the brightness of the pixels in the display.

FIG. 1C illustrates a detailed block diagram of the block 19 of FIG. 1A. Specifically, data of the EGP curve are input into an analog to digital converter (ADC) 190. The converted digital data are latched by a latch 192 and stored in a user-accessible register 194 in sequence, under control of a counter 196.

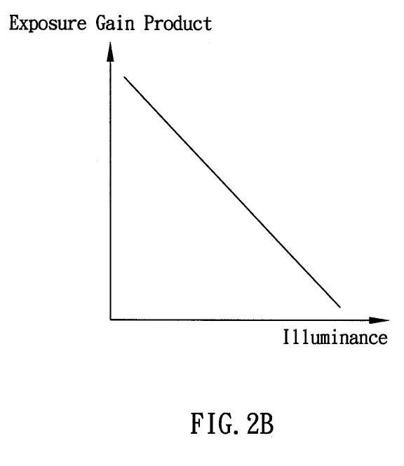

FIG. 2A, according to an alternative embodiment of the present invention, illustrates an apparatus for an image sensor 12, in which an off-chip auto exposure (AE) control loop 18B is placed on the ISP chip 140, which is distinct from the sensor chip 120. The off-chip AE control loop determines and applies the appropriate exposure, analog gain and digital gain to the sensor.

In this alternative embodiment, an EGP curve is also obtained as shown in FIG. 2B, which as presently embodied is the same as FIG. 1B. According to this EGP curve (FIG. 2B), the EGP has a substantially linear relationship to the illuminance as shown, such that the EGP may be utilized to determine the light intensity of the ambient light. In an AE control loop, the applied exposure and gain is limited to optimize image quality. When the exposure and gain product can no longer be adjusted, the light intensity captured by the sensor has a direct relation to the ambient light condition. Under this condition, the image sensor can quantify light intensity utilizing a separate measurement circuit. The combinations of the EGP curve (FIG. 1B) and measured light intensity are then quantified and/or digitized and stored (block 19).

Referring back to FIG. 1A, according to the embodiment, the AE control loop 18B controls the exposure gain product (EGP), based on the target object in the scene. Specifically, the scene is separated into several windows whereby the AE algorithm places a weighting factor for each window. The weighting factors determine the influence that each window has on the normalized measured brightness of the target scene. Accordingly, the EGP provides the integrated light meter that is capable of measuring the ambient light intensity based on the target object in the scene. Owing to the adjustability of the weighting factor for each window, the control of the display brightness can be flexibly adapted to different conditions and applications.

### Mode II

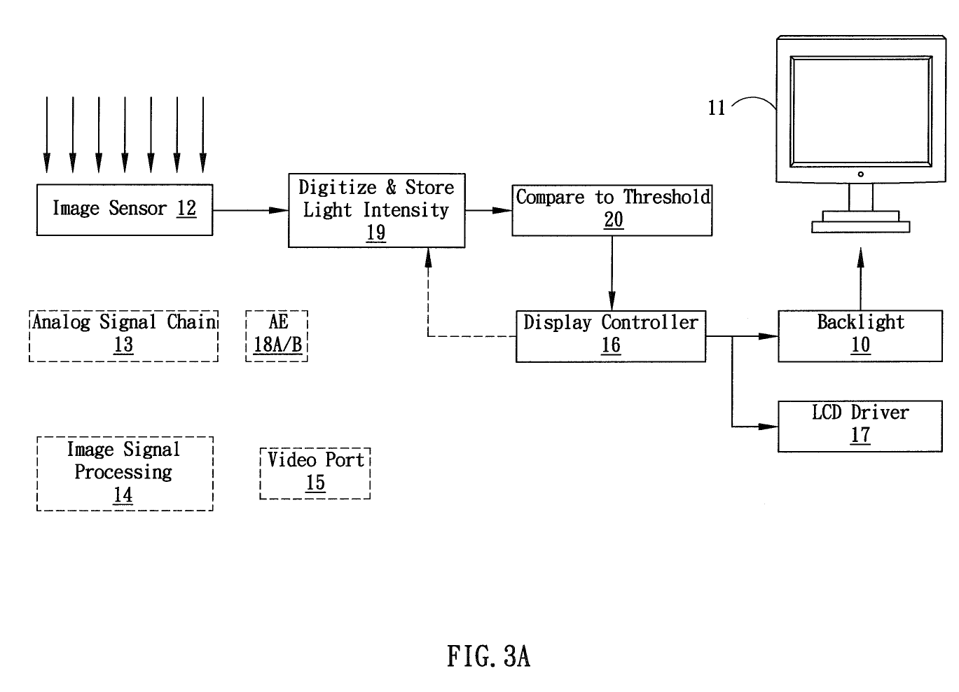

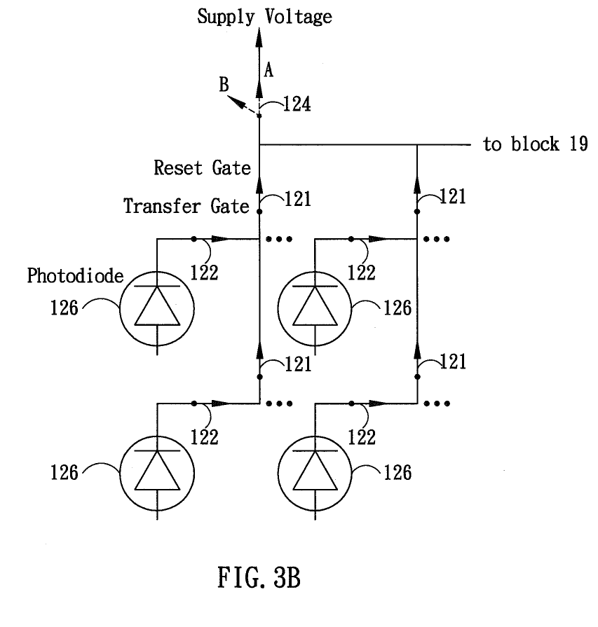

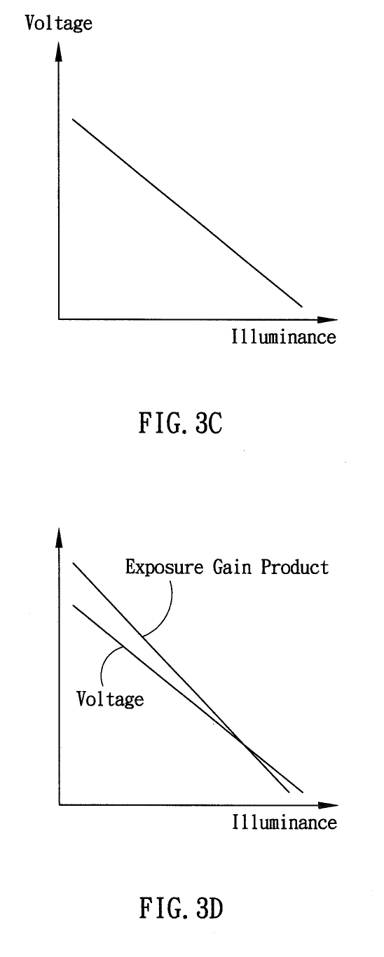

When the image sensor 12 is not used for capturing and outputting image data, the analog signal chain 13, the ISP 14, the video port 15, and the AE control loop 18A/B become inactive, as illustrated in FIG. 3A, wherein the dotted blocks indicate the inactiveness of the corresponding blocks. During this mode, the image sensor 12 continuously captures light without activating its readout path, thereby operating in a low-power way. Since the photodiode of the image sensor 12 is continuously exposed and collecting a light signal, the light signal is directly measured using the integrated light meter as discussed above.

FIG. 3B illustrates the resetting and integrating of the image sensor 12 when the image sensor 12 is not imaging. During this mode, all photosensors of the image sensor 12 are connected by turning on reset gates 120 and transfer gates 122 to obtain the ambient light intensity. A control gate 124 is, firstly, reset (i.e., closed at the position A) momentarily to the supply voltage. Subsequently, the control gate 124 is opened (at the position B) to allow the reset voltage to change based on electron charge in the photodiodes 126.

In this mode, an intensity curve is obtained as shown in FIG. 3C, which illustrates a typical relationship between the light signal (in voltage) and associated illuminance (or ambient light intensity). FIG. 3D shows the difference between the intensity curve of FIG. 3C and the EGP curve of FIGS. 1B and/or 2B. The EGP curve of FIG. 1B/2B can be correlated and approximated to the intensity curve of FIG. 3C, for example, by a programmable gain factor.

For the embodiments discussed above, the output signal of the block 20 may be connected to, for example, an INTERRUPT pin of a device controlling the backlight 10. Accordingly, whenever the threshold criteria in the block 20 have been met, the measured light intensity of the ambient light is read from the block 19 and utilized to generate an interrupt signal for adjusting the backlight 10. Alternatively, according to another embodiment, a conventional pulse width modulation (PWM) circuit is used instead. Whenever the threshold criteria in the block 20 have been met, the measured light intensity of the ambient light is read from the block 19 and utilized to generate a PWM signal for ultimately adjusting the backlight 10.

The embodiments disclosed above may be used, in other embodiments, to measure separate color channels of the image sensor 12, in order to provide an image sensor with an integrated color light meter for performing color light sensing functions. The measured separate color channels may be utilized to respectively control, for example, separate color lighting elements in the backlight 10.

According to the operations in Mode I and Mode II discussed above, the image sensor 12 with an integrated low-power light meter can be used to automatically adjust the display brightness based on the ambient light in the environment, both when the image sensor 12 is imaging and is not imaging. Accordingly, a low-power image sensor with an integrated ambient light meter is obtainable, and the system space and cost can be substantially reduced compared to a conventional system with a discrete ambient light photo sensor.

Although specific embodiments have been illustrated and described, it will be appreciated by those skilled in the art that various modifications may be made without departing from the spirit and scope of the present invention, which is intended to be limited solely by the appended claims.

What is claimed is:

1. A display with an integrated light meter, comprising:
an image sensor; and
an automatic exposure (AE) control loop configured to measure ambient light intensity, when the image sensor is imaging, for adjusting the brightness of the display;
wherein, when the image sensor is not imaging, the image sensor is continuously exposed and collecting light signal for determining the ambient light intensity.

2. The display according to claim 1, wherein the AE control loop is on-chip to be placed on the same chip as the image sensor.

3. The display according to claim 1, wherein the AE control loop is off-chip to be placed on a chip distinct from that of the image sensor.

4. The display according to claim 1, wherein the AE control loop obtains an exposure gain product (EGP) when the image sensor is imaging.

5. The display according to claim 4, wherein an intensity curve having a relationship with the light signal of the image sensor and the ambient light intensity is obtained, when the image sensor is not imaging.

6. The display according to claim 5, further comprising correlating the EGP to the intensity curve.

7. The display according to claim 6, further comprising means for digitalizing and storing the intensity curve or the correlated EGP.

8. The display according to claim 7, further comprising threshold means for comparing data read out of the digitizing means with a predetermined threshold.

9. The display according to claim 8, further comprising a backlight module controlled according to an output of the threshold means.

10. The display according to claim 9, further comprising an interrupt pin associated with the backlight module, such that when threshold criteria in the threshold means have been met, data read from the digitizing means is utilized to generate an interrupt signal for adjusting the backlight module.

11. The display according to claim 9, further comprising a pulse width modulation (PWM) circuit, such that when threshold criteria in the threshold means have been met, data read from the digitizing means is utilized to generate a PWM signal for adjusting the backlight module.

12. The display according to claim 1, wherein:
the image sensor comprises a plurality of photodiodes, each photodiode corresponding to a transfer gate and a reset gate; and
when the image sensor is not imaging, the transfer gates and the reset gates of the photodiodes are turned on for outputting the light signal.

13. A method for controlling display brightness, comprising:
providing an image sensor;
measuring an ambient light intensity by an automatic exposure (AE) control loop when the image sensor is imaging;
measuring the ambient light intensity by collecting a light signal from the image sensor when the image sensor is not imaging; and
adjusting the display brightness according to the ambient light intensity.

14. The method according to claim 13, wherein the AE control loop is on-chip for placement on the same chip as the image sensor.

15. The method according to claim 13, wherein the AE control loop is off-chip for placement on a chip distinct from that of the image sensor.

16. The method according to claim 13, wherein the AE control loop obtains an exposure gain product (EGP) when the image sensor is imaging.

17. The method according to claim 15, wherein an intensity curve having a relationship with the light signal of the image sensor and the ambient light intensity is obtained, when the image sensor is not imaging.

18. The method according to claim 17, further comprising correlating the EGP to the intensity curve.

19. The method according to claim 18, further comprising a step of digitalizing and storing the intensity curve or the correlated EGP.

20. The method according to claim 19, further comprising a step of comparing output of the digitized intensity curve with a predetermined threshold.
